(19) United States
(12) Patent Application Publication
(10) Pub. No.: US 2023/0263116 A1
(43) Pub. Date: Aug. 24, 2023

(54) PLANT CULTIVATION APPARATUS AND METHOD

(71) Applicants: Mitsubishi Chemical Aqua Solutions Co., Ltd., Tokyo (JP); Creo Technology Co,. Inc., Saitama (JP)

(72) Inventors: Junya FUSE, Tokyo (JP); Satoru MATSUNO, Tokyo (JP); Yasutaka AZUMAYA, Tokyo (JP); Yasumasa MIYAKE, Saitama (JP); Yuichiro TAKASAKI, Saitama (JP); Seiichi AKIMOTO, Saitama (JP)

(73) Assignees: Mitsubishi Chemical Aqua Solutions Co., Ltd., Tokyo (JP); Creo Technology Co,. Inc., Saitama (JP)

(21) Appl. No.: 18/308,291

(22) Filed: Apr. 27, 2023

Related U.S. Application Data
(63) Continuation of application No. PCT/JP2021/039317, filed on Oct. 25, 2021.

(30) Foreign Application Priority Data
Oct. 28, 2020 (JP) 2020-180146
Feb. 26, 2021 (JP) 2021-030534

(51) Int. Cl. A01G 31/04; A01G 31/06

(52) U.S. Cl. CPC A01G 31/04; A01G 31/06

(57) ABSTRACT

A plant cultivation apparatus including a conveyor that contains a conveying device for a cultivation bed and a blowing means that sends a flow of air to plants on the cultivation bed on the conveying device. The plant cultivation apparatus is provided with a space for causing the flow of air to pass between the cultivation bed adjacent in a conveying direction and pass through a bottom surface of the conveying device.

### TECHNICAL FIELD

The present invention relates to an apparatus and a method for cultivating plants.

### BACKGROUND ART

As a plant cultivation apparatus for cultivating plants such as vegetables, PTL 1 discloses an apparatus that is configured such that conveyors for cultivation beds are set at multiple vertical stages and move the cultivation beds sequentially.

In PTL 1, a substantially rectangular lighting blower panel is disposed so as to cover the upper side of a plurality of the cultivation beds on the conveyors, and air is blown toward plants from a blower pipe or a blower that is provided at the lighting blower panel (paragraphs 0016, 0020 and FIG. 2 of the patent literature).

PTL 2 discloses a plant cultivation apparatus in which seedling nursing shelves are disposed at multiple vertical stages. In PTL 2, a rear panel is provided at the rear of a seedling space between the seedling nursing shelves, the rear panel has a vent hole, and an air fan is set at the vent hole. By actuating the air fan, a flow of air is supplied through the vent hole to the seedling space.

### CITATION LIST

### Patent Literature

PTL 1: JP2019-216685A
PTL 2: JP2017-55720A

### SUMMARY OF INVENTION

### Technical Problem

In PTL 2, the flow of air flows from the rear toward the front in the seedling space and thus does not easily enter a space between the cultivation beds that are adjacent to each other on the same plane.

In PTL 1, air is blown to plants from the blower pipe or the blower set at the lightings blower panel above the conveyors (paragraph 0020, line 4 of PTL 1). However, since the lighting blower panel is provided at the conveyors, a wind that is sent to the plants flows sideward after applied to the plants and hardly enters the space between the cultivation beds adjacent to each other on the same plane.

As described above, in conventional plant cultivation apparatuses, most part of wind flows above plants. Therefore, the wind is not easily applied to the growing points of the plants such as vegetables directly, and uniformity of the flow of air (wind) at the periphery of the plants is decreased. There is thus a likelihood of occurrence of growth disorder such as tipburn.

An object of the present invention in one aspect is to provide a plant cultivation apparatus and a method capable of sufficiently applying wind (flow of air) to plants that are cultivated on a cultivation bed.

In addition, an object of the present invention in one aspect is to provide a plant cultivation apparatus and a method in which an influence of blockage of light of a lighting by a blower duct for sending a flow of air is small.

Further, an object thereof is to provide a plant cultivation apparatus and a method in which a long distance is provided between a lighting and a cultivation surface.

In addition, an object of the present invention in one aspect is to provide a plant cultivation apparatus and a method capable of improving uniformity of the temperature at a cultivation area that has a wide surface whose width and length is long.

### Solution to Problem

Features of the present invention are as follows:
[1] A plant cultivation apparatus comprising:
   a conveyor that includes a conveying device for a plurality of cultivation beds; and
   a blowing means that sends a flow of air toward plants on the cultivation beds on the conveying device,
   wherein the conveyor includes two or more stages of conveyors,
   wherein the blowing device is provided for each of the stages of the conveyors, and
   wherein the conveying device is provided with a space for causing the flow of air to pass between the cultivation beds and pass through a bottom surface of the conveying device.
[2] The plant cultivation apparatus according to [1], wherein an interval between the cultivation beds is 40 to 500 mm.
[3] The plant cultivation apparatus according to [1] or [2], wherein the blowing means includes an air conditioner that sucks air inside a cultivation room in which the plant cultivation apparatus is set and that causes the air to become conditioned air having a temperature in a predetermined range, and a blower duct to which adjusted air in which the conditioned air from the air conditioner and the air inside the cultivation room are mixed together is supplied and from which the adjusted air is blown out toward the cultivation beds.
[4] The plant cultivation apparatus according to [3], wherein the blower duct is set in a moving direction of the conveying device.
[5] The plant cultivation apparatus according to any one of [1] to [4], wherein the conveyors are set at multiple vertical stages.
[6] The plant cultivation apparatus according to any one of [1] to [5], wherein a longer direction of each of the cultivation beds intersects with a moving direction of the conveying device.
[7] A plant cultivation apparatus comprising:
   a conveyor that includes a conveying device for a cultivation bed; and
   a blowing means that applies a flow of air to plants on the cultivation bed on the conveying device from above,
   wherein the plant cultivation apparatus includes lighting devices that emit light toward the plants on the cultivation bed, and
   wherein a blower duct is disposed between at least some of the lighting devices.
[8] The plant cultivation apparatus according to [7],
   wherein the conveyor includes two or more stages of conveyors,
   wherein the blowing device is provided for each of the stages of the conveyors, and wherein the conveyors and the conveying device are provided with a space for causing the flow of air to pass between cultivation beds and pass through a bottom surface of each of the conveyors.
[9] A plant cultivation apparatus comprising a lighting that is disposed in a direction along a blower duct, wherein a PPF output per 1 m of the lighting is 150 μmol/s or more.
[10] The plant cultivation apparatus according to any one of [7] to [9], comprising a cultivation bed and the lightings disposed above the cultivation bed, wherein a PPFD value at an upper surface of the cultivation bed is 100 to 1000 μmol/m²/s.
[11] The plant cultivation apparatus according to any one of [7] to [10], wherein a height from an upper surface of the cultivation bed to the lightings is 300 to 1500 mm.
[12] The plant cultivation apparatus according to any one of [7] to [11], wherein an upper limit value of an interval (y) between the lightings is obtained from a height (x) from an upper surface of the cultivation bed to the lightings and a half value (θ) of a half-angle 2θ of each of the lighting by Formula (1) below:

[Math. 1]

y=x tan θ (1)
where, in Formula (1),
y: a setting interval [cm] of lightings,
x: a height [cm] from an upper surface of a cultivation bed to lightings, and
θ: a half value of a half-angle 2θ [°] of each lighting.
[13] The plant cultivation apparatus according any one of [7] to [12], wherein the lightings are LED lightings, and a setting range of the blower duct is outside a light distribution range of a half-angle 2θ of each of the LED lightings.
[14] The plant cultivation apparatus according any one of [7] to [13], an upper limit of a cross-sectional area (S) of the blower duct is a value obtained from an effective width (a) of a portion of each of the lightings on an upper side from a light source portion, a setting interval (y) of the lightings, and a half value (θ) of a half-angle of each of the lightings by Formula (2) below:

$$\begin{matrix}[ Math . 2 ] & \\ S = \frac{{y}^{2}}{4 tan θ} + ay & ( 2 )\end{matrix}$$

where, in Formula (2),
S: a cross-sectional area [cm²] of a blower duct,
a: an effective width [cm] of a portion of each lighting on an upper side from a light source portion,
y: a setting interval [cm] of lighting, and
θ: a half value of a half-angle 2θ [°] of each lighting.
[15] The plant cultivation apparatus according to any one of [7] to [14], wherein a cross-section of the blower duct has a substantially circular shape, and an upper limit value of a diameter (R) of the blower duct is obtained from an effective width (a) of a portion of each of the lightings on an upper side from a light source portion and a setting interval (y) of the lightings by Formula (3) below:

$$\begin{matrix}[ Math . 3 ] & \\ R = \{ \begin{matrix}y & ( R > y ) \\ \frac{2 a sin θ + y cos θ}{sin θ + 1} & ( R \leq y )\end{matrix} & ( 3 )\end{matrix}$$

where, in Formula (3),
R: a diameter [cm] of a blower duct,
a: an effective width [cm] of a portion of each lighting on an upper side from a light source portion,
y: a setting interval [cm] of lightings, and
θ: a half value of a half-angle 2θ [°] of each lighting.
[16] The plant cultivation apparatus according any one of [7] to [15], wherein each of the cultivation beds is covered by a cultivation plate having planting holes.
[17] The plant cultivation apparatus according to [16], wherein the planting hole includes one row of planting holes disposed in a longer direction of the cultivation beds.
[18] A plant cultivation apparatus wherein a temperature difference on cultivation beds at stages is within a range of ±1° C.
[19] The plant cultivation apparatus according to any one of [1] to [18], wherein both a length of one cultivation surface in a longitudinal direction and a length of the one cultivation surface in a transverse direction are 2 m or more.
[20] A plant cultivation method of cultivating plants by using the plant cultivation apparatus according to any one of [1] to [19].
[21] The plant cultivation method according to [20], wherein the plants are leafy vegetables of Asteraceae, such as frilly lettuce, batavia lettuce, and salad lettuce, Brassicaceae, such as komatsuna and bok choy, or Amaranthaceae, such as spinach, or fruit vegetables of Rosaceae, such as strawberry, or Solanaceae, such as tomato.

### Advantageous Effects of Invention

According to one aspect of the present invention, a flow of air that has been conditioned in an air conditioner can be supplied directly to the periphery of the growing points of plants cultivated on a cultivation bed. Consequently, growth disorder such as tipburn is suppressed, and it is also possible to increase harvest weight. In addition, plant cultivation environments become uniform, and plants of uniform quality can be cultivated.

In addition, in one aspect of the present invention, an influence of blockage of light of an illuminator by a blower duct for sending a flow of air can be reduced. Therefore, air can be blown from above plant bodies. As a result, a wide cultivation surface can be ensured.

According to one aspect of the present invention, by disposing a lighting device and a blowing duct with a large distance from plants, it is possible to improve uniformity of temperature at a cultivation area.

### BRIEF DESCRIPTION OF DRAWINGS

FIG. 1 is a sectional view of a plant cultivation apparatus according to an embodiment, illustrating a sectional view along line I-I of FIG. 2.

FIG. 2 is a sectional view along line II-II of FIG. 1.

FIG. 3 is a schematic perspective view illustrating a configuration of conveying devices and cultivation beds.

FIG. 4 is a schematic perspective view illustrating a relationship between cultivation beds and ducts.

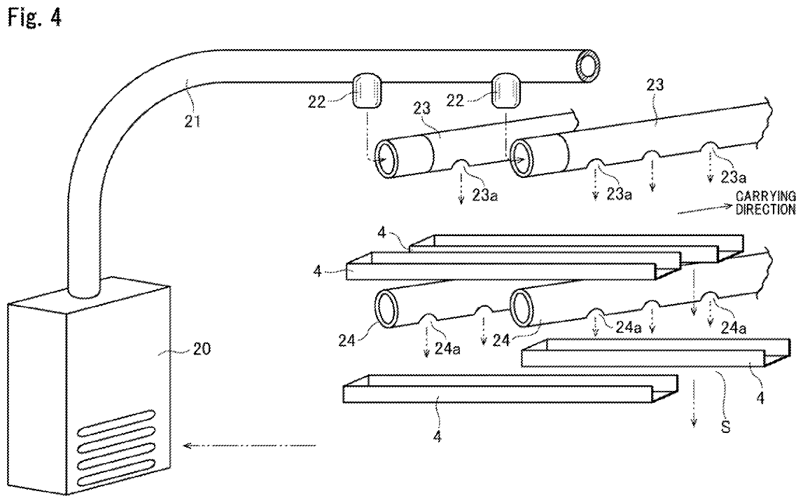

FIG. 5 is a perspective view illustrating a conveying device.

FIG. 6 is an explanatory view describing a formula.

### DESCRIPTION OF EMBODIMENTS

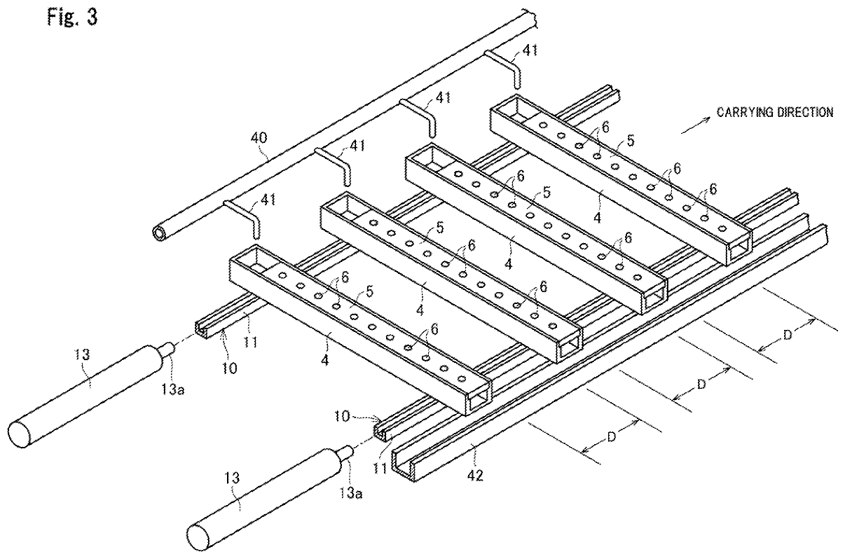

Hereinafter, a plant cultivation apparatus according to an embodiment will be described with reference to the drawings. As described above, FIG. 3 is a schematic perspective view illustrating a configuration of conveying devices and cultivation beds. However, the length of each of the cultivation beds is illustrated to be shorter than the actual length thereof in FIG. 3, and actual cultivation beds are longer than those illustrated in FIG. 3.

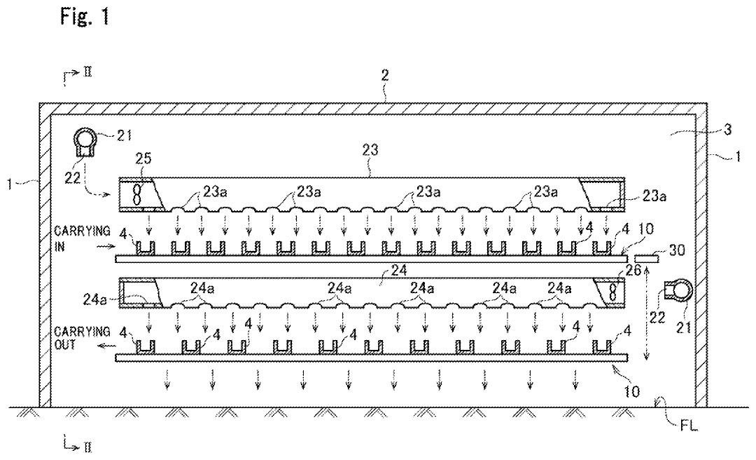

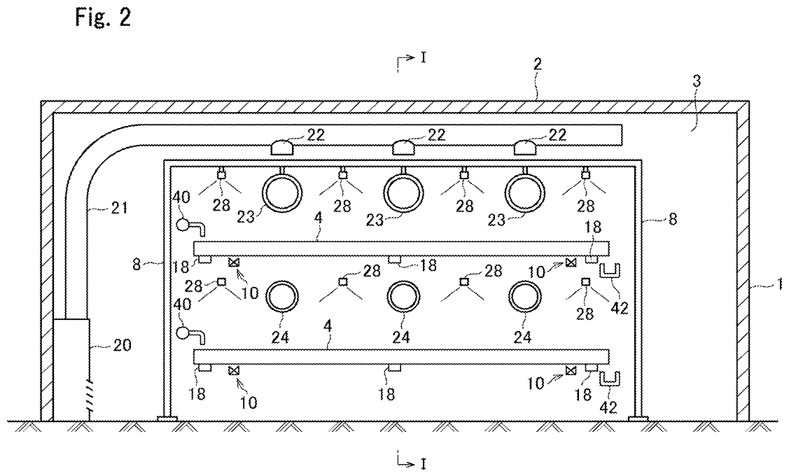

As illustrated in FIG. 1 and FIG. 2, conveyors for carrying a plurality of cultivation beds 4 are set at upper and lower two stages in a cultivation room 3 that is surrounded by a wall 1 and a ceiling 2. For each of the conveyors, conveying devices 10 that carry the plurality of cultivation beds 4 are set. Each conveyor may include, in addition to the conveying devices 10, a driver of the conveying device. In the present embodiment, a cylinder 13, described later, is provided as a driver. Blowing means that each send a flow of air toward plants are provided above the conveying devices 10. In the present embodiment, wind (flow of air) blower ducts 23 and 24 and lightings 28 are each set as blowing means above the conveying devices 10. As illustrated in FIG. 2, conditioned air that has been adjusted to a predetermined temperature by an air conditioner 20 is supplied to the blower ducts 23 through a main duct 21. In the present embodiment, as a blowing means, the air conditioner 20 is further included. The air conditioner 20 causes air in the cultivation room in which the plant cultivation apparatus is set, to become conditioned air having a temperature in a predetermined range.

The conveying devices 10 are provided so as to carry the cultivation beds 4 from the left to the right in FIG. 1 at the upper stage and from the right to the left in FIG. 1 at the lower stage. The conveying devices 10 are disposed below the cultivation beds 4 so as to be at one end side and the other end side in the longer direction of the cultivation beds 4. The conveying devices 10 may be disposed from one end side toward the other end side in the longer direction of the cultivation beds 4 and may be disposed from the other end side toward the one end side.

A lift table 30 for moving the cultivation beds 4 that have been carried to the right end side in FIG. 1 by the conveying devices 10 at the upper stage onto the conveying devices 10 at the lower stage is set. The lift table 30 can be lifted and lowered between the conveying devices 10 at the upper stage and the conveying devices 10 at the lower stage by a lifter device (not illustrated).

As specifically described later, the cultivation beds 4 are each configured such that seedlings are inserted into planting holes 6 provided in a cultivation plate 5 and hydroponically cultivated with nutrient solution.

The conveying device 10, the blower ducts 23 and 24, and the lightings 28 are each supported at a frame 8 (FIG. 2). In addition, liquid supply pipes 40 (FIG. 2 and FIG. 3) for supplying the nutrient solution to one end side of the cultivation beds 4, and raingutter-shaped drainage trays 42 (FIG. 2 and FIG. 3) for receiving the nutrient solution that flows out from the other end side of the cultivation beds 4 are also supported at the frame 8.

The nutrient solution in a nutrient reservoir (not illustrated) can be supplied to one end of each of the liquid supply pipes 40 for the nutrient solution by a pump.

In this embodiment, the cultivation beds 4 each have a long gutter-like shape whose upper face is open and whose cross-section perpendicular to the longer direction has a U-shape. In this embodiment, the cultivation beds 4 are disposed in a direction intersecting with the moving direction of the conveying device 10. The cultivation beds 4 are preferably disposed in an orthogonal direction. The cultivation beds 4 are not limited to be long and may have a shape whose width and depth are substantially the same.

The nutrient solution is supplied to one end side of the cultivation beds 4 from the liquid supply pipes 40 through nozzles 41. The bottom surface of each of the cultivation beds 4 has a water-flow slope that is inclined from the one end side toward the other end side in the longer direction, and the nutrient solution flows from the one end side toward the other end side in the cultivation beds 4 and flows out to the drainage trays 42.

The drainage trays 42 are set so as to have a water-flow slope. The nutrient solution that has flowed out from the downstream ends of the drainage trays 42 is returned to the nutrient reservoir through a collecting pipe (not illustrated).

The upper surface of each of the cultivation beds 4 is covered by the cultivation plate 5 having a lid-like shape. The cultivation plate 5 has a large number of the planting holes 6 that are disposed at intervals in the longer direction. The planting holes 6 are disposed in one row in the longer direction of the cultivation plate 5 in this embodiment but may be disposed in two or more rows.

The planting holes 6 extend through the cultivation plate 5. Seedlings (not illustrated) are to be inserted into the planting holes 6 from above.

The seedlings are inserted into the planting holes 6 such that roots of the seedlings are in contact with the nutrient solution that flows along the bottom surface of the cultivation bed 4.

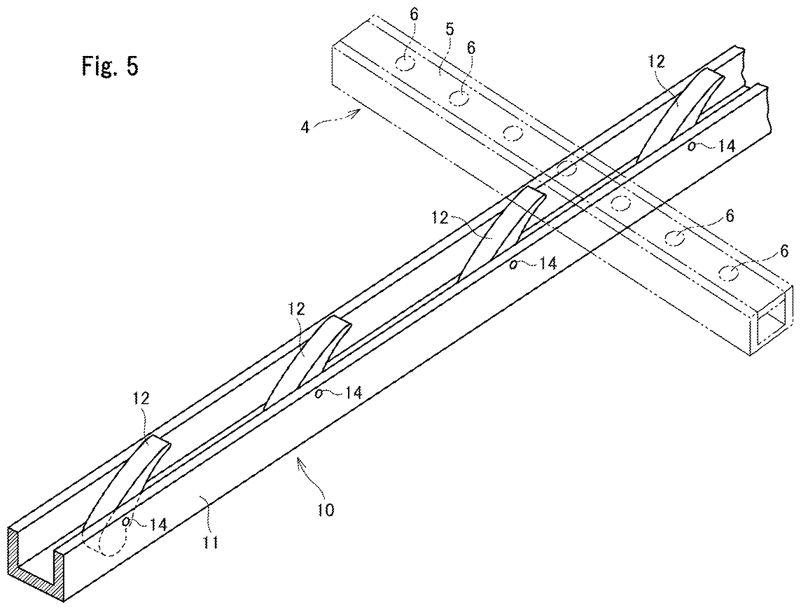

The cultivation beds 4 are disposed to be slidable and movable on guide rails 18 extending in the moving direction. As illustrated in FIG. 3 and FIG. 5, the conveying devices 10 that move the cultivation beds 4 on the guide rails 18 in the moving direction each include a rod 11 whose cross-section perpendicular to the longer direction has a U-shape, claws 12 that is provided at the rod 11, a cylinder (air cylinder in this embodiment) 13 that causes the rod 11 to reciprocate in the longer direction, and the like. One end of the rod 11 is connected to a piston rod 13a of the cylinder 13. The claws 12 are disposed at intervals in the longer direction of the rod 11.

Each of the claws 12 is attached to the rod 11 in a tiltable manner by a shaft pin 14. Each claw 12 is in an orientation protruding from the upper surface of the rod 11 due to the weight of a portion of the claw 12 on the lower side from the shaft pin 14.

When the piston rod 13a protrudes to move the rod 11 in the moving direction (forward movement direction), the claws 12 come into contact with a side lower portion of each of the cultivation beds 4. Then, with the forward movement of the rod 11, the cultivation beds 4 move forward by being pushed by the claws 12.

The claws 12 are tilted toward the downstream side in the moving direction of the cultivation beds 4. When the piston rod 13a is retreated to move the rod 11 in a counter moving direction (backward movement direction), each claw 12 rotates (tilts) around the shaft pin 14 so as to slide into the lower side of the cultivation beds 4, the claws 12 become not to protrude from the rod 11, and the rod 11 is retreated without the claws 12 catching the cultivation bed 4.

As described above, this embodiment employs an intermittent movement mechanism in which, at every time of the protruding stroke of the piston rod 13a of the cylinder 13, the cultivation beds 4 are moved to the downstream side in the moving direction by the amount of a stroke length of the piston rod 13a. Stop positions of the cultivation beds 4 are below the liquid supply nozzles 41.

The liquid supply nozzles 41 are each provided with a valve and, only when the cultivation beds 4 are stopped below the liquid supply nozzles 41, opens the valve so that the nutrient solution is discharged through the nozzles 41. While the cultivation beds 4 are moving, the valve is closed to stop discharging.

Each conveyor carries the cultivation beds 4 such that a predetermined interval D (FIG. 3) is provided between the cultivation beds 4 that are carried on the conveying devices 10. The interval D is preferably 40 to 500 mm.

Specifically, although an appropriate interval is different depending on the types of plants and early to later phases of cultivation, an interval of about 45 mm to 90 mm for the early phase of cultivation, an interval of about 90 mm to 135 mm for the middle phase of the cultivation, and an interval of about 135 mm to 180 mm for the later phase of the cultivation are suitable for leaf lettuce.

As illustrated in FIG. 1, the interval D at the conveyor at the lower stage is larger than the interval D at the conveyor at the upper stage in this embodiment. This is because the plants at the lower stage grow further than the plants at the upper stage.

In a case of cultivating leafy vegetables, in particular, leaf lettuce at upper and lower two stages, the conveyor at the upper stage corresponds to the early phase of the cultivation to the middle phase of the cultivation. Therefore, the interval D is the same as the interval for the early phase of the cultivation to the middle phase of the cultivation, and about 45 mm to 135 mm is suitable as the interval D. The conveyor at the lower stage corresponds to the middle phase of the cultivation to the later phase of the cultivation, and the interval D is the same as the interval for the middle phase of the cultivation to the later phase of the cultivation. Thus about 90 mm to 180 mm is suitable as the interval D. Note that, although depending on the types of plant bodies, leafy vegetable, such as leaf lettuce and salad lettuce, having spreading leaves is 45 mm to 180 mm, and leafy vegetable, such as chives and rocket, having upwardly extending leaves is about 45 mm throughout the early phase of cultivation to the later phase of the cultivation since the interval for the early phase of the cultivation to the later phase of the cultivation is not required to largely changed.

The blower ducts 23 are disposed above the conveyor at the upper stage, and the blower ducts 24 are disposed above the conveyor at the lower stage and below the conveyor at the upper stage. The blower ducts 23 extend in the moving direction of the cultivation beds 4. The blower ducts 23 and 24 are provided three each in this embodiment. However, it is preferable that the number thereof is selected, as appropriate, in accordance with the width of each of the cultivation beds 4, and the number thereof may be one and may be plural.

The conditioned air from the air conditioner 20 is blown out downwardly from the main duct 21 through blow-out ports 22. Most of the conditioned air is sucked into the blower ducts 23 to flow in the blower ducts 23 and, at intermediate portions thereof, blown out downwardly from the blow-out ports 23a. At this time, in addition to the conditioned air from the air conditioner 20, peripheral air is sucked into the blower ducts 23 and the blower ducts 24 due to that the blow-out ports 22 are set away from the blower ducts 23 and the blower ducts 24. As a result, the conditioned air becomes adjusted air whose temperature and humidity are adjusted. The blower ducts 23 and 24 blow out the adjusted air in which the conditioned air and air in the cultivation room are mixed together toward the cultivation beds.

The air suction volume of a blower 25 is preferably about three times the air discharge volume of the air conditioner 20. The air that is blown out from the air conditioner and the peripheral air are mixed together to cause the temperature of air that is sent into the ducts to become more than or equal to a dew-point temperature outside the ducts. Consequently, it is possible to prevent dew condensation from occurring on the surfaces of the ducts and prevent dew condensation water from dropping onto the plants under cultivation. In addition, since the temperature in the blowing ducts can be caused to be close to the temperature in the cultivation room, dew condensation and adverse effects of the dew condensation on plants are suppressed.

Most of the adjusted air that is blown out from the blow-out ports 23a is applied to the plants on the cultivation beds 4 at the upper stage and is blown to the lower stage through spaces between the cultivation beds 4. At this time, most of the adjusted air passes through spaces provided at the bottom surfaces of the conveying devices 10. In the present embodiment, the spaces provided at the bottom surfaces of the conveying devices 10 are common to the spaces of the conveyors, and most of the adjusted air passes the bottom surfaces of the conveyors. Consequently, moisture transpired from plants does not remain between leaves of the plants, and tipburn is easily suppressed. Further, leaf surface boundary layers are separated, and absorption of carbon dioxide by the plants is improved.

The adjusted air that has reached the terminal ends of the blower ducts 23 without being blown out from the blow-out ports 23a stops at the ends of the blower ducts 23 and consequently maintains the pressure in the blower ducts 23.

Most of the adjusted air that has been blown out from the blow-out ports 23a and blow-out ports 24a is applied, together with a flow of air that has been blown from the upper stage, the plants on the cultivation beds 4 at the lower stage, passes through the spaces between the cultivation beds 4, passes between the cultivation beds 4 and a floor FL, and returns along the floor FL to the air conditioner 20. The spaces do not only mean that the cultivation beds 4 are disposed with intervals therebetween but also mean that the spaces are spaces that enable the adjusted air to pass between the cultivation beds 4 and reach the lower side of the cultivation beds 4.

As described above, the adjusted air that has been blown out from the blow-out ports 23a and 24a is not only applied from above to the plants on the cultivation beds 4 but also downwardly passes through the spaces between the cultivation beds 4. Therefore, air is sufficiently applied also to the growing points of the plants, and a temperature difference on the cultivation beds is reduced. Consequently, growth disorder such as tipburn is suppressed, and plants of favorable quality can be efficiently cultivated. As a result of the growth disorder being suppressed, a longer growing period can be provided. It is thus possible to obtain plants of a large harvest weight.

The main duct 21 is provided along an upper portion of the wall 1 of the cultivation room 3 to extend in a direction intersecting with, preferably, orthogonal to the moving direction. The main duct 21 is provided with a plurality of blow-out ports 22 such that the conditioned air is blown downward or obliquely downward. As illustrated in FIG. 2, the blow-out ports 22 are each disposed above or near the front of a corresponding one of the blower ducts 23 at one end side with an interval from the inlet of the blower duct. Similarly, blow-out ports through which the adjusted air is blown out are provided also above or near the front of the blower ducts 24 at one end side.

At one end side (left end side in FIG. 1) of the blower ducts 23, the blower 25 for sending the conditioned air into the blower ducts 23 is provided.

At the other end side (right end side in FIG. 1) of the blower ducts 24, a blower 26 for sending the conditioned air into the blower ducts 24 is provided.

Although the adjusted air may be caused to flow in directions that are identical to each other in the blower ducts 23 and the blower ducts 24, it is preferable to cause the adjusted air to flow in directions opposite to each other since, by causing the adjusted air to flow in directions opposite to each other, air that is present at a distant location in the cultivation room is sent into the blowers and flows of air in mutually opposite directions are generated in the cultivation room. Consequently, the air in the cultivation room does not remain therein, and it is thus possible to improve the uniformity of the temperature of the entirety of the system.

The blower ducts 23 and 24 have blow-out ports 23a and 24a, respectively, in the lower surfaces thereof. A plurality of the blow-out ports 23a and 24a are disposed at lower portions of the blower ducts 23 and 24 and in an obliquely downward direction to a height that is half the height of each of the blower ducts 23 and 24 so as to be symmetrical to the axis of each of the blower ducts 23 and 24 in the longer direction when the blower ducts 23 and 24 are projected onto the cultivation surfaces. An arrangement of the blow-out ports 23a and 24a at certain locations in the longer direction of the blower ducts 23 and 24 is referred to as an arrangement pattern. The blow-out ports 23a of the blower ducts 23 and the blow-out ports 24a of the blower ducts 24 are preferably arranged in different arrangement patterns having regularity in the longer direction. Different arrangement patterns having regularity can increase the uniformity of wind that is supplied to plant bodies.

The opening diameter of each of the blow-out ports 23a and 24a is preferably about 10 mm to 30 mm. With the opening diameter in the aforementioned range, wind is blown out from the blow-out ports radially. Thus, wind can be sent from above the plants. Note that the wind velocity is determined by the areas and the air volumes of the blow-out ports 23a and 24a. Therefore, while the opening area of a total of the blow-out ports is defined by the air volumes of the blowers, 1,500 to 40,000 m², in particular, about 4,000 to 10,000 m² is suitable as the total of the opening areas of the blow-out ports 23a and 24a. Consequently, it is possible to reduce the influence of pressure loss and possible to supply the adjusted air that is uniform in the longer direction to plant bodies. Note that, while the blow-out ports 23a and 24a each have a circular shape, the blow-out ports 23a and 24a are not limited thereto. In the case where non-circular blow-out ports are employed, it is preferable that the opening area thereof be similar to the opening area of each of the circular blow-out ports 23a and 24a.

As a distance (center-to-center distance) of mutually adjacent blow-out ports 23a, an interval of 100 mm to 200 mm, in particular, about 150 mm to 170 mm is suitable.

The velocity of the adjusted air that is blown out from the blow-out ports 23a and 24a is preferably 0.2 to 1.0 m/s and more preferably 0.2 to 0.4 m/s. The wind velocity of the adjusted air that passes between the cultivation beds 4 is preferably 0.1 to 0.5 m/s and more preferably 0.1 to 0.2 m/s. Being set within the aforementioned range, the wind velocity becomes a wind velocity that does not apply a burden on the growth of the plant bodies, and disorder of the plant bodies is reduced. The wind velocity is measured at a location that is above and away from the planting holes 6 by 50 mm with an anemometer that is set in a direction in which the flow of wind from above can be measured.

The lightings 28 of the present invention are linear light sources in this embodiment. The light sources of the lightings 28 may be linear light sources constituted by LED chips that form several tens to several hundreds of point light sources and may be linear light sources constituted by COB-type LEDs that are integrated to be linearly long. The linear light sources may be each constituted by a plurality of bulb-shaped lightings that are arranged in series. Alternatively, the linear light sources may be each constituted by a plurality of rows in each of which a plurality of light sources are linearly arranged. Although not particularly limited, the shape of each light source is preferably a bar-shaped since it is easy to set the light sources at a location at which the light sources do not interfere with the blower ducts 23 and 24 and it is possible to reduce the height of the entirety of the apparatus by minimizing the height of the light sources. The lightings 28 are disposed to extend from one end side to the other end side of the conveyors. At least some of the lighting devices are disposed between the blower ducts 23 or 24.

Preferably, the blower ducts 23 and/or 24 are set such that part or the entirety thereof is positioned below the height of the lower surfaces of the illuminators 28 and outside a light distribution range of a half-angle 2θ of each of the lightings 28. When the blower ducts 23 and/or 24 are set in such a positional relationship, the space inside the apparatus does not easily include a dead space in the height direction and is effectively used easily.

The lightings 28 are set parallel to the blower ducts 23 and 24. At the upper stage, the lightings 28 are provided in four lines in total between the blower ducts 23 and outward therefrom. At the lower stage, the lightings 28 are also provided in four lines in total between the blower ducts 24 and outward therefrom. Such lightings 28 and the positional relationship between the lightings 28 and the blower ducts 23 or 24 may be used in combination with the above-described plant cultivation apparatus in which the above-described space for causing a flow of air to pass to the lower side of the cultivation beds.

By using LED lighting devices as the lightings 28, it is possible to provide a wide space between the lighting devices and thus is possible to set a blower duct between the lighting devices. As a result, it is possible to suppress an influence of blockage of light by the blower duct.

By setting a small number of lines of lighting devices as lighting devices and setting the PPF output of each of the lighting per 1 m to 150 μmol/s or more, it is possible to set a small number of the lighting devices with wide intervals between the lighting devices. It is thus possible to irradiate plants with lighting light substantially uniformly. The PPF output value of each of the lightings per 1 m is more preferably 200 μmol/s or more, further more preferably 250 μmol/s or more, particularly preferably 300 μmol/s or more, and most preferably 350 μmol/s or more. PPF denotes photosynthetic photon flux. The PPF output denotes the amount of photons emitted from a lighting device per second and, regarding lighting fixture for general lighting, corresponds to total luminous flux (lm: lumen), which indicates the performance of the lighting devices itself, of the lighting devices.

Such lightings are preferably applied to the above-described plant cultivation apparatus in which the space for causing a flow of air to flow between the cultivation beds adjacent to each other in the moving direction and to pass to the lower side of the cultivation beds and the above-described plant cultivation apparatus in which the blower ducts are disposed between at least some of the lightings. By being applied to these plant cultivation apparatuses, the lightings 28 can be provided with a long distance from the cultivation beds 4 and eventually can increase the uniformity of the temperature. Furthermore, it is possible to provide a plant cultivation apparatus in which cultivation surfaces are wide in two directions that differ from each other.

The PPFD at the upper surfaces of the cultivation beds 4 is set to 100 to 1000 μmol/m²/s. The PPFD is more preferably 120 to 500 μmol/m²/s and further more preferably 150 to 300 μmol/m²/s. As the PPFD, an average PPFD, which is an average value, may be used. The average PPFD is the arithmetic mean of all of measurement points.

The PPFD denotes the number of photons that reach a light reception surface of light per unit area and per second and, regarding general lighting, corresponds to illuminance (Lx: lux) indicating the brightness at the light reception surface. Note that the PPFD is measured with a photosynthetic photon flux density sensor that is set at a measurement point while peripheral lightings are turned off to prevent invasion of light other than that of lightings 28.

The height from the upper surface of each of the cultivation beds 4 to the lightings is preferably within the range of y/tan θ to 2y/tan θ, where y is the setting interval of the lightings and 2θ is the half-angle of each of the lightings. Specifically, the height is preferably 300 to 1500 mm, more preferably 400 to 1300 mm, further more preferably 500 to 1100 mm, and particularly preferably 600 to 900 mm. With the height within the aforementioned range, it is possible to cause the distribution of the PPFD at the cultivation surfaces to become uniform while maintaining lightings efficiency.

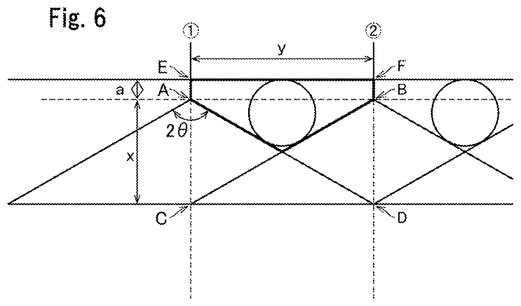

As illustrated in FIG. 6, the upper limit value of the interval y between the illuminators 28 is obtained from a half value (θ) of the half-angle 2θ of each of the lightings and a height (x) from the upper surface of each cultivation bed 4 to the lightings 28 by Formula (1) below.

[Math. 4]

y=x tan θ (1)

In Formula (1), y: a setting interval [cm] of lighting devices, x: a height [cm] from an upper surface of a cultivation bed to each lighting devices, and θ: a half value of the half-angle 2θ[°] of each of lighting devices.

The setting interval of the lightings denotes a distance between the centers of the lightings. Regarding the interval between bar-shaped lighting devices, the center in the longer direction and the width direction is considered as the center of each lighting. In addition, the height (x) from the upper surface of each cultivation bed to the lightings is the height from the upper surface of each of the cultivation beds 4 to the surface of a cover on the emission-surface-side of each lighting. When the lighting has no cover, the height (x) from the upper surface of each cultivation bed to the lightings is the height from the upper surface of each cultivation bed 4 to light sources of the lightings.

By setting the upper limit value of the interval y between the lightings 28 to a value obtained by Formula (1) above, it is possible to cause the light that is applied to plant bodies to become uniform.

The half-angle 2θ of each of the illuminators is preferably within the range of 120°±30°.

The setting ranges of the blower ducts 23 and 24 are outside the light distribution range of the half-angle 2θ of each of the lightings. The lightings 28 are preferably LED lighting devices.

The range outside the light distribution range of the half-angle 2θ of each of the LED lighting devices is a region that is surrounded by the line segment AE, the line segment EF, the line segment FB, the line segment AD, and the line BC in FIG. 6, and the area of the region is expressed by Formula (2) below. The line AD and the line BC indicate the half-angle 2θ of each of the lightings 28. The half-angle 2θ is measured by using, as a reference, the center axis of the light that is emitted from a light source and denotes an aperture angle at which the brightness is ½ of the brightness at the center axis of the light source.

By setting the setting range of the blower ducts to be outside the light distribution range of the half-angle 2θ of each of the lightings, it is possible to supply the lightings light and the adjusted air to the plant bodies uniformly and possible to obtain light distribution, temperature distribution, and humidity distribution that are uniform throughout the entirety of the system. Further, it is possible to set the width and the depth of the system to be longer than before. As a result of the temperature distribution and the humidity distribution becoming uniform, it is possible to obtain plant bodies of uniform and favorable quality.

The upper limit value of a cross-sectional area (S) of each blower duct is obtained from an effective width (a) of a portion of each of the lightings on the upper side from a light source portion, a setting interval (y) of the lightings, and a half value (θ) of the half-angle 2θ of each of the lightings by Formula (2) below.

The effective width (a) of the portion of each of the lightings on the upper side from the light source portion is a width from the outer surface of the cover on the emission-surface-side of the lighting to the attached position of the lighting. When a plurality of the blower ducts are set at each setting location for the blower ducts, the cross-sectional area (S) is a total area of the cross-sectional areas of the plurality of blower ducts at each of the setting locations. When no cover is present on the emission-surface-side, a distance from the light source portion of the lighting to the attached position of the lighting is considered as the effective width (a).

$$\begin{matrix}[ Math . 5 ] & \\ S = \frac{{y}^{2}}{4 tan θ} + ay & ( 2 )\end{matrix}$$

Note that, in Formula (2), S: a cross-sectional area [cm²] of each blower duct, a: an effective width [cm] of a portion of each lighting on the upper side from a light source portion, y: a setting interval [cm] of lightings, and θ: a half value of the half-angle 2θ[°] of each lighting.

When the cross-section of each blower duct is substantially circular, the upper limit value of a diameter (R) of the blower duct is obtained from the effective width (a) of the portion of each of the lightings on the upper side from the light source portion and the setting interval (y) of the lightings by Formula (3) below.

By setting the diameter of each blower duct to be less than or equal to a value obtained by Formula (3), it is possible to set the blower duct at a location at which the blower duct does not block, of the light emitted from the lightings, light within the range of the half-angle 2θ.

$$\begin{matrix}[ Math . 6 ] & \\ R = \{ \begin{matrix}y & ( R > y ) \\ \frac{2 a sin θ + y cos θ}{sin θ + 1} & ( R \leq y )\end{matrix} & ( 3 )\end{matrix}$$

Note that, in Formula (3), R: a diameter [cm] of each blower duct, a: an effective width [cm] of a portion of each lighting on the upper side from a light source portion, y: a setting interval [cm] of lightings, θ: a half value of the half-angle 2θ[°] of each lighting.

The diameter of each blower duct is preferably 10 cm or more. The diameter is more preferably 15 cm or more and further more preferably 20 cm or more. By setting the diameter to be more than or equal to the aforementioned lower limit value, it is easy to adjust the air volume.

When the diameter of each blower duct is expressed by Formula (4) below, where R [cm] is the diameter of the blower duct and L [cm] is the length thereof, the value of a coefficient b is preferably a thickness of more than or equal to 0.433, more preferably a thickness of more than or equal to 0.577, and further more preferably a thickness of more than or equal to 0.7. By setting the diameter to a thickness that is more than or equal to the lower limit value with respect to the length of each blower duct set on the cultivation surface, it is possible to apply uniform wind to plants while maintaining efficiency of the blowers set at the blower ducts.

[Math. 7]

R=b\sqrt{L} (4)

In the plant cultivation apparatus that is configured as described above, in a state in which the air conditioner 20 is actuated and the lightings 28 are turned on, the cultivation beds 4 on which seedlings are planted are disposed at the inlet side (left side in FIG. 1) of the conveyor at the upper stage by human power or a conveying machine and carried intermittently in the rightward direction in FIG. 1 by the conveying device 10 at the upper stage. The cultivation beds 4 are moved intermittently by the amount of each stroke of the piston rod 13a.

The cultivation beds 4 that have been moved to the right end side of the conveying devices 10 at the upper stage are carried onto the conveying devices 10 at the lower stage by the lift table 30 and intermittently carried from the right end side to the left end side in FIG. 1 sequentially by the conveying devices 10 at the lower stage.

During this time, the nutrient solution is supplied to each of the cultivation beds 4 through the liquid supply pipes 40 for the nutrient solution and the nozzles 41.

In the plant cultivation apparatus of the present invention, a temperature difference on the cultivation beds at the stages is within the range of ±1° C.

By reducing a difference between the inlet side and the end side of each of the blowing ducts 23 and 24 in terms of the temperature of the adjusted air, it is possible to reduce the temperature difference on the cultivation beds to be within the range of ±1° C. In conventional plant factories, a method of expanding the shape of a cultivation surface is only expansion in the longer direction thereof. Meanwhile, in a method of the present application, expansion is possible in either of the longer direction and the shorter direction, and a cultivation apparatus having a wide cultivation surface can be achieved. By expanding a cultivation surface in both directions of the longer direction and the shorter direction, the percentage of peripheral edge portions is reduced, and utilization efficiency of light of lightings can be improved.

Such a plant cultivation apparatus is preferably applied to the above-described plant cultivation apparatus in which a space for causing a flow of air to pass between the cultivation beds adjacent to each other in the moving direction and pass to the lower side of the cultivation beds, the above-described plant cultivation apparatus in which the blower ducts are disposed between at least some of the lightings, and the above-described plant cultivation apparatus in which the PPF output of the lightings per 1 m is 150 μmol/s or more.

Although depending on the diameters of the blowing ducts 23 and 24, suitable wind velocity of the adjusted air in the blowing ducts 23 and 24 is 10 m/s to 60 m/s, in particular, 30 m/s to 40 m/s. For example, when the diameters of the blowing ducts 23 and 24 are 0.16 m to 0.25 m, suitable wind velocity in the blowing ducts 23 and 24 is 31 m/s to 38 m/s and, when the diameters of the blowing ducts 23 and 24 are 0.14 m to 0.45 m, 5 m/s to 60 m/s, in particular, 7 m/s to 40 m/s. For example, when the length of each of the blowing ducts is 10 m, a time required for reaching from the blowers 25 and 26 to the ends of the blowing ducts is about 0.3 seconds, which is significantly short. It is thus possible to reduce a temperature difference between the inlet and the terminal end of each of the blowing ducts to become noticeably small.

A suitable air volume of each of the blower 25 and 26 is 0.1 m³/s to 2.5 m³/s, preferably 0.3 m³/s to 2.2 m³/s, more preferably 0.5 m³/s to 2.0 m³/s, further more preferably 0.7 m³/s to 1.8 m³/s, and particularly preferably 0.8 m³/s to 1.6 m³/s. Note that, depending on the variety of leafy vegetables, there is a case where growth disorder such as tipburn does not occur even when the air volume is outside the suitable range. In such a case, blowers whose air volume is outside the suitable range may be introduced.

If the air volumes of the blowers 25 and 26 are not excessive, it is considered that the whole volume of the air is applied to the vegetables through the blowing ducts 23 and 24. Thus, the air volumes of the blowers 25 and 26 may be considered to be substantially the same as the air volume that is applied to the vegetables.

In addition, when the blower ducts 23 and 24 are disposed outside the range of the light distribution angle of each of the lightings, it is possible to reduce the influence of the blower ducts 23 and 24 receiving the light of the lightings and increasing the temperature of the air that flows in the blower ducts 23 and 24. Therefore, the temperature of the adjusted air hardly changes during a period from when the adjusted air enters from the blowers 25 and 26 to when the adjusted air flows to the outside from the blow-out ports 23a and 24b by passing through the blowing ducts 23 and 24. It is thus possible to reduce a temperature difference on the cultivation beds.

Note that the above-described temperature difference is obtained by measuring temperatures with temperature sensors that are set on the cultivation beds to be disposed at intervals from 5 m to 10 m in the longer direction of the direction of the cultivation beds and at intervals of 2 m to 5 m in the shorter direction of the cultivation beds and calculating a difference between the maximum value and the minimum value at each of the stages.

In the cultivation apparatus of the present invention, both the length of one cultivation surface in the longitudinal direction and the length of the one cultivation surface in the transverse direction are 2 m or more. Due to being a system that blows air from the sides of plant bodies, a conventional plant cultivation apparatus is required to be short in the air blowing direction to provide the air volume that is required for the plant bodies and that does not damage the plant bodies. Thus, it has been necessary to design a cultivation surface to be long to increase the area of the cultivation surface. The plant cultivation apparatus of the present application can cause air blowing and light irradiation to become uniform and thus can increase the uniformity of temperature distribution, light intensity, and wind strength. It is thus possible to achieve a cultivation apparatus having cultivation surfaces that are long in both the longitudinal direction and the transverse direction. In addition, with the cultivation surfaces that are wide in the longitudinal and transverse directions, the percentage of peripheral edge portions is reduced. It is thus possible to improve the utilization efficiency of light of lightings.

While the conveyors are set at multiple vertical stages in the aforementioned embodiment, the conveyors may be disposed at one stage or at three stages or more, for example, three to ten stages. The number of the stages is preferably an even number since, if the early and middle phases of cultivation of plants and the later phase of the cultivation are performed separately at two stages, it is possible to start and end the carrying of the cultivation beds 4 from the same side of the system and possible to design the entirety of the system compactly.

While the conveying devices are disposed at upper and lower two stages in the aforementioned embodiment, the conveying devices are not limited to be disposed at upper and lower two stages and may be disposed at one stage or at three stages or more, for example, three to ten stages. The number of the stages is preferably an even number since, if the early and middle phases of cultivation of plants and the later phase of the cultivation are performed separately at two stages, it is possible to start and end the carrying of the cultivation beds 4 from the same side of the system and possible to design the entirety of the system compactly.

The cultivation beds are moved from the upper stage to the lower stage in the aforementioned embodiment but may be transferred reversely.

While the cultivation beds 4 are intermittently moved by the cylinder 13 in the aforementioned embodiment, a power mechanism other than cylinders may be used. Alternatively, the cultivation beds 4 may be moved by another moving mechanism such as a chain moving mechanism. The cultivation beds 4 may be moved continuously instead of intermittently.

This plant cultivation apparatus is suitable for cultivation of leafy vegetables of Asteraceae, such as frilly lettuce, batavia lettuce, and salad lettuce, Brassicaceae, such as komatsuna and bok choy, and Amaranthaceae, such as spinach, and fruit vegetables of Rosaceae, such as strawberry, Solanaceae, such as tomato, and the like but is not limited thereto.

In the aforementioned embodiment, the lightings 28 are disposed between the blower ducts 23, between the blower ducts 24, and at two sides thereof, and the lightings 28 are set in (N+2) lines, where (N+2) is a number that is obtained by adding two to the number N of the blower ducts. However, a larger number of the lightings may be set.

While linear light sources are presented as an example of the lightings 28 in the aforementioned embodiment, the lightings 28 may be point light sources and may be area light sources. The width of each of the lightings 28 is preferably a half value of y in the above-described formula (1), that is, y/2 or less. From the point of view of the blower ducts 23 and the lightings 28 preventing the light emitted from the lightings from not to be used efficiently as a result of the light being blocked by point light sources or the blower ducts 23, the width of the lightings 28 is preferably y/4 or less.

The distance between end portions of the lightings 28 is preferably a half value of y in the above-described formula (1), that is, y/2 or less. The distance between the end portions of the lightings 28 is a distance between, of two lightings 28 closest to each other with the blower duct 23 interposed therebetween, respective end portions closest to the blower duct 23. When the lightings 28 are not continuous in a direction along the blower duct 23, a distance between, of two lightings 28 closest to each other in the direction along the blower duct 23, respective end portions closest to each other is also considered as a distance between the end portions of the lightings 28. From the point of view of the blower ducts 23 and the lightings 28 preventing the light emitted from the lightings from not to be used efficiently as a result of the light being blocked by point light sources or the blower ducts 23, the distance between the end portions of the lightings 28 is preferably y/4 or less.

### EXAMPLES

[Basic Conditions]

As basic conditions, a channel shaped cultivation bed disposed at a slope of 1/80 has a cultivation plate in which six planting holes are formed, a nutrient solution (nutrient solution electric conductance: EC2.0 dS/m; nutrient solution temperature: 20° C.) is supplied at a flow rate of 0.6 liters per minute to the bottom surface of the cultivation bed, and frilly lettuce and batavia lettuce were cultivated. At this time, a cultivation area had a width of 1300 mm and a length of 1800 mm.

[Evaluation Method]

(1) Occurrence Rate of Tipburn

A growing point of each harvested plant was exposed by hand peeling so that tipburn in the vicinity of the growing point can be visually observed. Whether tipburn was present was confirmed by visual observation. When an outer leave of each plant or an outer leave near the growing point was discolored to brown or black, it was determined that tipburn had occurred. The evaluation was performed based on that the percentage of the number of plants that each include at least one portion in which tipburn had occurred to the number of total cultivated plants was considered the occurrence percentage of tipburn.

(2) Harvest Weight

At the time of harvest, an upper portion of a medium was cut with scissors and dead leaves and discolored leaves were removed one by one. Then, the remaining portion was placed on a scale to measure the weight thereof.

### Example 1

As a cultivation bed, a cultivation gutter (width 75 mm, length 1300 mm, height 60 mm) was used, and the height from the upper surface of the cultivation gutter to lightings was set to 800 mm. As the lightings, two LED lighting devices whose length is 1.25 m and power consumption is 200 W were used. The half-angle 2θ of each of the LED lightings was 120°, the PPF output thereof was 500 μmol/s, the average PPFD value was 200 μmol/m²/s. The interval between the LED lighting was set to 800 mm. The PPFD is an average value measured at an interval of 10 cm by setting a PPFD sensor (photosynthetic photon flux density sensor LI-190R manufactured by LI-COR) having a height of 35 mm on the upper surface of the cultivation gutter.

The wind velocity of adjusted air that is applied to plant bodies was set within the range of 0.2 m/s to 1.0 m/s, wind was caused to flow uniformly in a direction from above vegetables, and a space through which a flow of air passes was provided between the cultivation gutters to thereby ensure the flow of wind in the up-down direction.

The wind velocity is a value measured by a hot-wire sensitive anemometer (Anemocheck anemometer MODEL 6413 manufactured by KANOMAX JAPAN INC).

Harvesting was performed after 45 days of cultivation in total including 20 days of seeding and nursing of seedlings and 25 days of cultivation.

Occurrence rates of tipburn of the thus cultivated plant bodies and the harvest weights thereof were measured. Obtained results are indicated in Table 1.

### Comparative Example 1

Plant bodies were cultivated and harvested in the same manner as in Example 1 except that the following conditions were changed.

As cultivation beds, plane-type cultivation planters (width 300 mm, length 1300 mm, height 50 mm) each including a shelf lower portion bottom plate were used for two-line cultivation, and the height from the upper surface of each of the cultivation planters to lightings was set to 200 mm. As the lightings, ten LED lighting devices whose length is 1250 mm and power consumption is 20 W were used. The half-angle 2θ of each of the LED lightings was 120°, the PPF output thereof was 50 μmol/s, and the average PPFD was 200 μmol/m²/s. The interval between the LED lightings is set to 200 mm.

The wind velocity of adjusted air that is applied to plant bodies was set to 0.1 m/s or more, and wind was caused to flow toward vegetables from sides. A space through which a flow of air passes was not provided between the cultivation planters.

Harvesting was performed after 35 days of cultivation in total including 8 days of seeding, 14 days of nursing of seedlings, and 13 days of cultivation.

Results are indicated in Table 1.

TABLE 1

| | | Example | Comparative |
|---|---|---|---|
| | | 1 | Example 1 |
| Frilly | Number of plants harvested | 46 | 72 |
| lettuce | Number of tipburn plants | 0 | 2 |
| | Tipburn occurrence rate (%) | 0 | 2.8 |
| | Harvest weight (g/plant) | 390 | 128 |
| Batavia | Number of plants harvested | 46 | 36 |
| lettuce | Number of tipburn plants | 7 | 28 |
| | Tipburn occurrence rate (%) | 15.2 | 77.7 |
| | Harvest weight (g/plant) | 341 | 127 |

As indicated in Table 1, it was proved that the harvest weight per plant was larger in the method of the present application of the invention than in the conventional method by 262 g/plant (390 g/plant to 128 g/plant) for frilly lettuce and 214 g/plant (341 g/plant to 127 g/plant) for batavia lettuce.

This is because it was possible to increase the number of days of cultivation to be longer than that in the conventional method since the occurrence rate of tipburn of vegetables was low.

Meanwhile, the growth weight per day obtained by dividing the harvest weight by the number of days of cultivation was 8.67 g/day/plant for frilly lettuce and 7.58 g/day/plant for batavia lettuce in the method of the present invention, 3.66 g/day/plant for frilly lettuce and 3.63 g/day/plant for batavia lettuce in the conventional method, and it was confirmed that the method of the present invention was superior.

### Example 2

The width of each of cultivation surfaces was set to 5 m and the length thereof was set to 12 m, and the height from the height position at each of the cultivation beds 4 to the lower surface of each lighting was set to 800 mm. The cultivation surfaces were disposed at two stages of an upper stage and a lower stage. As lighting for each stage, nine LED lighting devices whose length is 1.25 m and PPF output is 500 μmol/s were set in series. At each stage, three blower ducts whose diameter is 30 cm and length is 12 m were set in four rows at an interval of 1.3 m. With this cultivation apparatus, temperature measurement of one day was performed. Measurement positions on the cultivation surfaces were nine points of C1 to C9. C1 to C5 are measurement positions at the upper stage, and C6 to C9 are measurement positions at the lower stage.

At C1, temperature near the center of the cultivation surface was measured. At C2 to C5, temperatures near the four corners of the cultivation surface were measured. At C6 to C9, temperatures at four corners of the cultivation surface were measured. Specifically, measurement was performed for C1 at a position away from an end of a cultivation frame at the upper stage by 0 m in the width direction and 7 m in the length direction and away from the cultivation bed at the upper stage by 0.8 m in the height direction, for C2 at a position away from the end by 0 m in the width direction and 2.5 m in the length direction and away from the cultivation bed at the upper stage by 0 m in the height direction, for C3 at a position away from the end by 0 m in the width direction and 13 m in the length direction and away from the cultivation bed at the upper stage by 0 m in the height direction, for C4 at a position away from the end by 5 m in the width direction and 2.5 m in the length direction and away from the cultivation bed at the upper stage by 0 m in the height direction, and for C5 at a position away from the end by 13 m in the length direction and 5 m in the width direction and away from the cultivation bed at the upper stage by 0 m in the height direction. Measurement was performed for C6 at a position away from an end of a cultivation frame at the lower stage by 0 m in the width direction and 2.5 m in the length direction and away from the cultivation bed at the lower stage by 0 m in the height direction, for C7 at a position away from the end by 0 m in the width direction and 13 m in the length direction and away from the cultivation bed at the lower stage by 0 m in the height direction, for C8 at a position away from the end by 5 m in the width direction and 2.5 m in the length direction and away from the cultivation bed at the lower stage by 0 m in the height direction, and for C9 at a position away from the end by 5 m in the width direction and 13 m in the length direction and away from the cultivation bed at the lower stage by 0 m in the height direction.

At the upper stage, the maximum temperature difference was 1.6° C., the minimum temperature difference was 0.4° C., and the average of the temperature differences was 0.97° C. At the lower stage, the maximum temperature difference was 1.8° C., the minimum temperature difference was 0.2° C., and the average of the temperature differences was 1.1° C. Accordingly, the temperature differences at the upper stage and the lower stages were within the range of ±0.90° C. and within the range of ±1° C.

### REFERENCE SIGNS LIST

Although the present invention has been described in detail by way of the specific modes, it is apparent for those skilled in the art that various changes can be made without departing from the spirit and scope of the present invention.

The present application is based on Japanese Patent Application No. 2020-180146 filed on Oct. 28, 2020, and Japanese Patent Application No. 2021-030534 filed on Feb. 26, 2021, the entire contents of which are incorporated herein by reference.
1 wall
2 ceiling
3 cultivation room
4 cultivation bed
5 cultivation plate
6 planting hole
8 frame
10 conveying device
11 rod
12 claw
13 cylinder
18 guide rail
20 air conditioner
21 main duct
23, 24 blower duct
30 lift table

1. A plant cultivation apparatus comprising:
a conveyor that includes a conveying device for a cultivation bed; and
a blowing means that sends a flow of air to plants on the cultivation bed on the conveying device,
wherein the plant cultivation apparatus is provided with a space for causing the flow of air to pass between the cultivation bed adjacent in a conveying direction and pass through a bottom surface of the conveying device.

2. The plant cultivation apparatus according to claim 1, wherein an interval between the cultivation bed is 40 to 500 mm.

3. The plant cultivation apparatus according to claim 1, wherein the blowing means includes an air conditioner that sucks air inside a cultivation room in which the plant cultivation apparatus is set and that causes the air to become conditioned air having a temperature in a predetermined range, and a blower duct in which the conditioned air from the air conditioner and the air inside the cultivation room are mixed together is supplied to form adjusted air and from which the adjusted air is blown out toward the cultivation beds.

4. The plant cultivation apparatus according to claim 3, wherein the blower duct is set in a moving direction of the conveying device.

5. The plant cultivation apparatus according to claim 1, wherein the conveyor is set at multiple vertical stages.

6. The plant cultivation apparatus according to claim 1, wherein a longer direction of the cultivation bed intersects with a moving direction of the conveying device.

7. A plant cultivation apparatus comprising:
a conveyor that includes a conveying device for a cultivation bed; and
a blowing means that applies a flow of air to plants on the cultivation bed on the conveying device from above,
wherein the plant cultivation apparatus includes lighting devices that emit light toward the plants on the cultivation bed, and
wherein a blower duct is disposed between at least some of the lighting devices.

8. The plant cultivation apparatus according to claim 7,
wherein the conveyor includes two or more stages of conveyors,
wherein the blowing means is provided for each of the two or more stages of the conveyors, and
wherein the conveyors and the conveying device are provided with a space for causing the flow of air to pass between cultivation beds and pass through a bottom surface of each of the conveyors.

9. A plant cultivation apparatus comprising a lighting that is disposed in a direction along a blower duct, wherein a photosynthetic photon flux (PPF) output per 1 m of the lighting is 150 μmol/s or more.

10. The plant cultivation apparatus according to claim 7, wherein the lighting devices are disposed above the cultivation bed, and
wherein a photosynthetic photon flux density (PPFD) value at an upper surface of the cultivation bed is 100 to 1000 μmol/m²/s.

11. The plant cultivation apparatus according to claim 7, wherein a height from an upper surface of the cultivation bed to the lighting devices is 300 to 1500 mm.

12. The plant cultivation apparatus according to claim 7, wherein an upper limit value of an interval (y) between the lightings is obtained by Formula (1) below:
y=x tan θ (1)
where, in Formula (1),
y: a setting interval [cm] of the lighting devices,
x: a height [cm] from an upper surface of the cultivation bed to the lighting devices, and
θ: a half value of a half-angle 2θ[°] of each of the lighting devices.

13. The plant cultivation apparatus according to claim 7, wherein the lighting devices are LED lightings, and a setting range of the blower duct is outside a light distribution range of a half-angle 2θ of each of the LED lightings.

14. The plant cultivation apparatus according to claim 7, wherein, an upper limit of a cross-sectional area (S) of the blower duct is a value obtained by Formula (2) below:
$$S = \frac{{y}^{2}}{4 tan θ} + ay \qquad ( 2 )$$
where, in Formula (2),
S: the cross-sectional area [cm²] of the blower duct,
a: an effective width [cm] of a portion of each lighting device on an upper side from a light source portion,
y: a setting interval [cm] of the lighting devices, and
θ: a half value of a half-angle 2θ[°] of each of the lighting devices.

15. The plant cultivation apparatus according to claim 7, wherein a cross-section of the blower duct has a substantially circular shape, and an upper limit value of a diameter (R) of the blower duct is obtained by Formula (3) below:
$$R = \{ \begin{matrix}y & ( R > y ) \\ \frac{2 a sin θ + y cos θ}{sin θ + 1} & ( R \leq y )\end{matrix} \qquad ( 3 )$$
where, in Formula (3),
R: a diameter [cm] of the blower duct,
a: an effective width [cm] of a portion of each lighting device on an upper side from a light source portion,
y: a setting interval [cm] of the lighting devices, and
θ: a half value of a half-angle 2θ[°] of each of the lighting devices.

16. The plant cultivation apparatus according to claim 1, wherein the cultivation bed is covered by a cultivation plate having planting holes.

17. The plant cultivation apparatus according to claim 16, wherein the planting holes include one row of planting holes disposed in a longer direction of the cultivation bed.

18. A plant cultivation apparatus wherein a temperature difference on cultivation beds at stages is within a range of ±1° C.

19. The plant cultivation apparatus according to claim 1, wherein both a length of the cultivation bed in a longitudinal direction and in a transverse direction are 2 m or more.

20. A method of cultivating plants comprising cultivating the plants in the plant cultivation apparatus according to claim 1.

21. The plant cultivation method according to claim 20, wherein the plants are leafy vegetables of Asteraceae, Brassicaceae, or Amaranthaceae, or fruit vegetables of Rosaceae, or Solanaceae.
